(19) United States
(12) Patent Application Publication
(10) Pub. No.: US 2010/0294306 A1
(43) Pub. Date: Nov. 25, 2010

(54) METHOD AND SOLUTION FOR CLEANING SEMICONDUCTOR DEVICE SUBSTRATE

(75) Inventors: Hideaki Mochizuki, Fukuoka (JP); Makoto Ishikawa, Fukuoka (JP); Noriyuki Saito, Fukuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical Corporation, Tokyo (JP)

(21) Appl. No.: 12/746,025

(22) PCT Filed: Dec. 3, 2008
(86) PCT No.: PCT/JP08/71982

§ 371 Date: Jul. 27, 2010

(30) Foreign Application Priority Data
Dec. 4, 2007 (JP) 2007-313487

(51) Int. Cl. B08B 3/12; C11D 3/43

(52) U.S. Cl. 134/1.3; 510/175

(57) ABSTRACT

Provided is a method for cleaning a semiconductor device substrate, which is excellent in removability and re-adhesion-preventing properties of contaminations of fine particles or organic matter, metal contamination and combined contamination of organic matter and metal, which are adhered to a substrate surface, and which can highly clean the substrate surface without corroding it even when an intense ultrasonic wave is not applied.

It is a method for cleaning a semiconductor device substrate, the method comprising cleaning the semiconductor device substrate while applying an ultrasonic wave having an intensity of 0.2 W or more and 1.5 W or less per cm² of substrate to be irradiated with the ultrasonic wave by using a cleaning solution comprising the following components (A) to (D):
(A) hydrogen peroxide,
(B) an alkali,
(C) water, and
(D) a compound represented by the following general formula (1):

R¹—O—(—R²—O—)ₙ—H(1)

wherein R¹ represents an alkyl group having 1 to 4 carbon atoms, R² represents an alkylene group having 2 to 3 carbon atoms, and n represents an integer of 1 to 3.

### TECHNICAL FIELD

The present invention relates to a cleaning solution used for cleaning of substrate surfaces of semiconductor, glass, metal, ceramic, resin, magnetic body, superconductor or the like, in which metal contamination or particle contamination poses a problem, and relates to a cleaning method. More particularly, the invention relates to a cleaning method and a cleaning solution for effectively cleaning surfaces of semiconductor device substrates in production processes of the semiconductor device substrates for semiconductor elements, display devices or the like, in which highly clean substrate surfaces are required.

### BACKGROUND ART

In production processes of semiconductor devices such as microprocessors, logic LSI, DRAM, flush memory and CCD and flat panel display devices such as TFT liquid crystals, pattern formation or thin-film formation is performed on substrate surfaces of silicon, silicon oxide, glass or the like in a size ranging from submicron to nanometer order. In each production process, it has become an extremely important problem to decrease trace contaminations on the substrate surfaces. Of the trace contaminations on the substrate surfaces, particularly, particle contamination, organic matter contamination and metal contamination decrease electric characteristics and yield of the devices, so that it is necessary to decrease them as far as possible before being brought into subsequent processes. For removal of such contaminations, cleaning of the substrate surfaces by means of a cleaning solution is commonly performed.

Conventionally, it has been known that an alkaline solution is effective as the cleaning solution used for removal of the particle contamination of semiconductor device substrates, and an aqueous alkaline solution such as an aqueous ammonia solution, an aqueous potassium hydroxide solution or an aqueous tetramethylammonium hydroxide solution has been used for cleaning surfaces of the substrates for the semiconductor devices such as semiconductor elements and display devices. Further, cleaning (referred to as “SC-1 cleaning” or “APM cleaning”) by means of a cleaning solution (referred to as “an SC-1 cleaning solution” or “an APM cleaning solution”) containing ammonia, hydrogen peroxide and water has also been widely used (see non-patent document 1).

In recent years, miniaturization and high integration of the semiconductor devices have increasingly progressed, and further, in the production of the semiconductor devices, further improvements in throughput and further production efficiency have been required.

With this, also for cleaning of the substrate at the time of producing the semiconductor device substrates, there has been desired a technique which is excellent in removability of contaminations of particles, organic matter, metal and the like and in re-adhesion-preventing properties after contamination removal, and can rapidly perform cleaning without making a large impact to the substrates, particularly a technique excellent in removability of fine particles without making a large impact to the substrates.

Non-Patent Document 1: W. Kern and D. A. Puotinen: RCA Review, p. 187, June (1970)

### DISCLOSURE OF THE INVENTION

### Problems that the Invention is to Solve

The invention has been made in view of the above-mentioned circumstances. An objet of the invention is to provide a cleaning technique which is excellent in removability of contaminations of particles, organic matter, metal and the like, particularly in removability of fine particle contamination, and also excellent in re-adhesion-preventing properties after contamination removal, and which can rapidly clean a substrate surface without making a large impact to a substrate.

### Means for Solving the Problems

In order to solve the above-mentioned problems, the present inventors have made intensive studies. As a result, it has been found that the above-mentioned problems can be solved by performing cleaning while applying an ultrasonic wave by using a cleaning solution comprising specific components, thus completing the invention.

That is to say, a gist of the invention is as follows.

A method for cleaning a semiconductor device substrate of the invention comprises cleaning the semiconductor device substrate while applying an ultrasonic wave having an intensity of 0.2 W or more and 1.5 W or less per cm² of substrate to be irradiated with the ultrasonic wave by using a cleaning solution comprising the following components (A) to (D):

(A) hydrogen peroxide,

(B) an alkali,

(C) water, and

(D) a compound represented by the following general formula (1):

R¹—O—(—R²—O—)ₙ—H (1)

wherein R¹ represents an alkyl group having 1 to 4 carbon atoms, R² represents an alkylene group having 2 to 3 carbon atoms, and n represents an integer of 1 to 3.

Further, a method for cleaning a semiconductor device substrate of the invention comprises cleaning the semiconductor device substrate while applying an ultrasonic wave having a frequency of 0.5 MHz or more by using a cleaning solution comprising the following components (A) to (D):

(A) hydrogen peroxide,

(B) an alkali,

(C) water, and

(D) a compound represented by the following general formula (1):

R¹—O—(—R²—O—)ₙ—H (1)

wherein R¹ represents an alkyl group having 1 to 4 carbon atoms, R² represents an alkylene group having 2 to 3 carbon atoms, and n represents an integer of 1 to 3.

Still further, in the above-mentioned method for cleaning a semiconductor device substrate, the invention is characterized in that a solution temperature of the above-mentioned cleaning solution at the time of cleaning is from 20 to 50° C.

Yet still further, in the above-mentioned method for cleaning a semiconductor device substrate, the invention is characterized in that pH of the above-mentioned cleaning solution is from 9.0 to 12.0.

Furthermore, in the above-mentioned method for cleaning a semiconductor device substrate, the invention is characterized in that a content of the above-mentioned component (D) is from 50 to 5,000 ppm by weight.

Still furthermore, in the above-mentioned method for cleaning a semiconductor device substrate, the invention is characterized in that the above-mentioned component (B) is ammonium hydroxide.

Yet still furthermore, the invention is characterized in that a content of the above-mentioned component (B) is from 0.01 to 10% by weight.

In addition, in the above-mentioned solution for cleaning a semiconductor device substrate, the invention is characterized in that it is a composition comprising the following components (A) to (D):

(A) hydrogen peroxide,

(B) an alkali,

(C) water, and

(D) a compound represented by the following general formula (1):

R¹—O—(—R²—O—)ₙ—H (1)

wherein R¹ represents an alkyl group having 1 to 4 carbon atoms, R² represents an alkylene group having 2 to 3 carbon atoms, and n represents an integer of 1 to 3,

wherein a content of the above-mentioned component (A) is from 0.01 to 10% by weight,

a content of the above-mentioned component (B) is from 0.005 to 5% by weight, a content of the above-mentioned component (C) is from 85 to 99.5% by weight, and a content of the above-mentioned component (D) is from 50 to 5,000 ppm by weight.

### ADVANTAGES OF THE INVENTION

According to the invention, in a semiconductor device substrate having a semiconductor material such as silicon, an insulating material such as silicon nitride, silicon oxide, glass or a low-dielectric constant (low-k) material, or a transition metal or a transition metal compound, on a part or the whole of a surface, fine particles, organic contamination, metal contamination and combined contamination of organic matter and metal, which are adhered to the substrate surface, can be effectively removed by cleaning. Further, even when fine particles or the like come to be mixed in a system, re-adhesion thereof can be effectively inhibited.

In particular, the cleaning solution of the invention can remove fine particle contamination even by low-intensity ultrasonic irradiation giving small impact to the substrate, so that pattern inclination or the like is difficult to occur. Accordingly, cleaning properties and inhibition of substrate corrosion and pattern inclination are realized by carrying out cleaning with the special cleaning solution having a low carbon number while performing low-temperature, low-output low megasonic irradiation, that is to say, MHz-order ultrasonic irradiation. Thus, the invention is industrially extremely useful as a low-damage surface treatment technique for contamination cleaning and the like in production processes of semiconductor devices, display devices and the like in which miniaturization and high integration progress.

### BEST MODE FOR CARRYING OUT THE INVENTION

An embodiment of the invention will be described in detail below.

A cleaning solution for a semiconductor device substrate of the invention is used when the semiconductor device substrate is cleaned while applying a low-intensity ultrasonic wave, and comprises the following components (A) to (D). The method for cleaning a semiconductor device substrate of the invention comprises the following components (A) to (D), particularly component (D), when the cleaning is performed while applying an ultrasonic wave:

(A) hydrogen peroxide,

(B) an alkali,

(C) water, and

(D) a compound represented by the following general formula (1):

R¹—O—(—R²—O—)ₙ—H (1)

wherein R¹ represents an alkyl group having 1 to 4 carbon atoms, R² represents an alkylene group having 2 to 3 carbon atoms, and n represents an integer of 1 to 3.

<(A) Hydrogen Peroxide>

As hydrogen peroxide (A) contained in the cleaning solution of the invention, it is possible to use a commercially available hydrogen peroxide solution, and a production method thereof and the like are not particularly limited. In the cleaning solution of the invention, hydrogen peroxide is considered to have a function of first oxidizing a substrate surface in cleaning the semiconductor device substrate.

The concentration of hydrogen peroxide in the cleaning solution of the invention is, as the lower limit, preferably 0.01% by weight, more preferably 0.1% by weight and particularly preferably 0.5% by weight, and, as the upper limit, preferably 10% by weight, more preferably 5% by weight and particularly preferably 3% by weight. When the concentration of hydrogen peroxide is the above-mentioned lower limit or more, it is preferred in terms of prevention of surface roughening of the substrate and prevention of excessive etching. On the other hand, when the concentration thereof is the above-mentioned upper limit or less, it is preferred in terms of inhibition of decomposition of glycol ether-based compounds and reduction in cost and load of waste liquid treatment.

<(B) Alkali>

The kind of alkali contained in the cleaning solution of the invention is not particularly limited, and there may be used hydroxides of alkali metals or alkali earth metals such as sodium hydroxide, potassium hydroxide and calcium hydroxide, and alkaline salts such as sodium hydrogencarbonate and ammonium hydrogencarbonate. However, as the alkalis used in the invention, ammonium hydroxide (aqueous ammonia solution) and organic alkalis are preferred. The organic alkalis include amines such as quaternary ammonium hydroxides, amines and amino alcohols. As the quaternary ammonium hydroxide, preferred is one having a hydroxyl group, an alkoxy group, or an alkyl group having 1 to 4 carbon atoms or a hydroxyalkyl group having 1 to 4 carbon atoms which may be substituted with halogen. All of these substituents may be the same or different.

The alkyl groups as described above include lower alkyl group having 1 to 4 carbon atoms such as a methyl group, an ethyl group, a propyl group and a butyl group, and the hydroxyalkyl groups include lower hydroxyalkyl groups having 1 to 4 carbon atoms such as a hydroxymethyl group, a hydroxyethyl group, a hydroxypropyl group and a hydroxybutyl group.

Specific examples of the quaternary ammonium hydroxides having the above-mentioned substituents include tetramethylammonium hydroxide (TMAH), tetraethylammonium hydroxide, trimethyl(hydroxyethyl)ammonium hydroxide (commonly known as “choline”), triethyl(hydroxyethyl)ammonium hydroxide and the like. On the other hand, the amines include ethylenediamine, monoethanolamine, trimethanolamine and the like.

Of the alkalis described above, ammonium hydroxide is particularly preferred for reasons of cleaning effect, decreased metal remaining, economic efficiency, stability of the cleaning solution and the like. Such an alkali may be used either alone or as a combination of two or more thereof at any ratio.

In the cleaning solution of the invention, the alkali is considered to contribute to remove particles by etching oxides generated by hydrogen peroxide to lift off them.

The concentration of the alkali in the cleaning solution is, as the lower limit, preferably 0.005% by weight, more preferably 0.01% by weight and still more preferably 0.1% by weight, and, as the upper limit, preferably 10% by weight, more preferably 5% by weight and particularly preferably 3% by weight. When the concentration of the alkali is the above-mentioned lower limit or more, it is preferred in terms of particle removability. On the other hand, when the concentration thereof is the above-mentioned upper limit or less, it is preferred in terms of smoothness of the substrate surface after cleaning.

<(C) Water>

Water contained in the cleaning solution of the invention is preferably highly pure, particularly when it is desired to form a fine wiring on the semiconductor device substrate, and usually deionized water, preferably ultrapure water is used. Further, it is also possible to use electrolytic ionized water obtained by electrolysis of water or hydrogen water obtained by dissolving hydrogen gas in water. The specific resistance giving an indication of the conductive ion content as impurities is specifically preferably 1 MΩ·cm or more, and particularly preferably ten and several MΩ·cm or more.

The concentration of the water in the cleaning solution is, as the lower limit, preferably 85% by weight and more preferably 90% by weight, and, as the upper limit, preferably 99.5% by weight and more preferably 99% by weight. When the concentration of the water is the above-mentioned lower limit or more, it is preferred in terms of smoothness of the substrate surface after cleaning. On the other hand, when the concentration thereof is the above-mentioned upper limit or less, it is preferred in terms of particle removability.

<(D) Glycol Ether-Based Compound>

The cleaning solution of the invention contains a compound represented by the following general formula (1) from the viewpoints of cleaning properties, solubility to water and safety,

R¹—O—(—R²—O—)ₙ—H (1)

wherein R¹ represents an alkyl group having 1 to 4 carbon atoms, R² represents an alkylene group having 2 to 3 carbon atoms, and n represents an integer of 1 to 3.

The compound represented by the above-mentioned general formula (1) is generally called a glycol ether-based compound. R¹ is a hydrophobic group, and an alcohol moiety and an ether moiety of —O—(—R²—O—)ₙ—H are hydrophilic groups. Incidentally, when the both ends are hydrocarbon groups herein, solubility to water is low (when the both ends are butyl ether, the amount dissolved in water is about 0.3% by weight) although viscosity is low, and moreover, danger also becomes high. The reason why the cleaning solution of the invention is extremely excellent for removing fine particles even under conditions of low ultrasonic irradiation intensity is not clear. However, it is effective that R¹ is not an aromatic but an alkyl group, or that the carbon number of R¹ is smaller than that of a surfactant or the like. That is to say, it conceivably contributes that the compound has surface active ability and a small molecular weight.

In the above-mentioned general formula (1), R¹ represents an alkyl group having 1 to 4 carbon atoms. The carbon number of the alkyl group of R¹ is preferably larger in that the ability as the surfactant is easily exhibited, whereas it is preferably smaller in terms of solubility to water. As the glycol ether-based compound, there is generally used one in which the alkyl group of R¹ has a carbon number of up to about 12. The carbon number of the alkyl group of R¹ is preferably 4 or less in terms of solubility to water. Further, in terms of surfactant ability, it is preferably larger, more preferably 2 or more, particularly preferably 3 or more and most preferably 4. When the carbon number of the alkyl group of R¹ is small herein, it is more preferred to improve wettability by increasing the concentration thereof in the cleaning solution, corresponding to decreased surfactant ability of the glycol ether-based compound.

In the above-mentioned general formula (1), R² represents an alkylene group having 2 to 3 carbon atoms. R² is preferably an ethylene group from easy availability.

In the glycol ether-based compound represented by the above-mentioned general formula (1), n is preferably 3 or less and more preferably 2 or less, in terms of wettability and viscosity.

Of the above-mentioned glycol ether-based compounds, diethylene glycol n-butyl ether represented by the following structural formula (2), in which R¹ is CH₃CH₂CH₂CH₂, R² is CH₂CH₂, and n is 2, is preferred in terms of cleaning properties and environment.

(Chem. 1)

CH₃—CH₂—CH₂—CH₂—O—CH₂—CH₂—O—CH₂—CH₂—OH (2)
Hydrophobic Moiety Hydrophilic Moiety (Alcohol Moiety and Ether Moiety) Ether Moiety

These glycol ether-based compounds may be used either alone or as a combination of two or more thereof.

The concentration of component (D) in the cleaning solution is, as the lower limit, preferably 50 ppm by weight and more preferably 100 ppm by weight, and, as the upper limit, preferably 5,000 ppm by weight, more preferably 3,000 ppm by weight and particularly preferably 2,000 ppm by weight. When the concentration of component (D) is the above-mentioned lower limit or more, it is preferred in terms of particle removability. On the other hand, when the concentration thereof is the above-mentioned upper limit or less, it is preferred in terms of smoothness of the substrate surface after cleaning.

<Other Components>

The cleaning solution of the invention may further contain other components at any ratios within a range without imparting its performance. The other components include surfactants, complexing agents, anticorrosives such as sulfur-containing organic compounds (2-mercaptothiazoline, 2-mercaptoimidazoline, 2-mercaptoethanol, thioglycerol and the like), nitrogen-containing organic compounds (benzotriazole, 3-aminotriazole, N(R)₃ (R is an alkyl group having 1 to 4 carbon atoms), N(ROH)₃ (R is an alkyl group having 1 to 4 carbon atoms), urea, thiourea and the like), water-soluble polymers (polyethylene glycol, polyvinyl alcohol and the like) and alkyl alcohol-based compounds (ROH (R is an alkyl group having 1 to 4 carbon atoms)), acids such as sulfuric acid and hydrochloric acid, reducing agents such as hydrazine, dissolved gases such as hydrogen, argon and nitrogen, etching promoters from which an effect of removing polymers and the like firmly adhered after dry etching can be expected, such as hydrofluoric acid, ammonium fluoride and BHF (buffered hydrofluoric acid). Further, the other components which can be allowed to be contained in the cleaning solution of the invention also include oxidizing agents such as ozone and oxygen. In a cleaning process of the semiconductor device substrate, when a silicon (bare silicon) substrate surface having no oxide film is cleaned, surface roughening due to etching to the substrate surface can be inhibited by incorporation of the oxidizing agent. This is therefore preferred.

When the cleaning solution of the invention contains the surfactant, a nonionic type or an anionic type is preferred, and the cleaning solution containing both of them is more preferred. Incidentally, the commercially available surfactants contain slight amounts of impurities in many cases. In particular, the nonionic surfactants contain about 1 to thousands of ppm by weight of metal impurities such as Na, K and Fe or anion components such as halogen ions in a commonly marketed form in some cases. When such impurities are contained in the cleaning solution of the invention, there is a possibility that they become metal contamination and other contamination sources. In the cleaning solution of the invention, it is preferred for preventing metal contamination of the semiconductor device substrate due to cleaning that the content of each of at least Na, Mg, Al, K, Ca, Fe, Cu, Pb and Zn of the metal impurities in the cleaning solution is 20 ppb or less, especially 5 ppb or less and particularly 0.1 ppb or less. In particular, in the cleaning solution of the invention, the total content of these metal impurities is preferably 20 ppb or less, especially 5 ppb or less and particularly 0.1 ppb or less. In order to obtain such a purified surfactant, purification may be performed, for example, by dissolving the surfactant in water, and then, allowing the solution to pass through an ion exchange resin to trap the ionic impurities in the resin.

When the cleaning solution of the invention contains the complexing agent, an extremely highly clean surface is obtained on which metal contamination of the substrate surface is further decreased. This is therefore preferred. When the complexing agent is used, any conventionally known one can be used. A proper one may be selected by comprehensively judging from the contamination level of substrate surface, the kind of metal, the cleanliness level required for the substrate surface, the cost of the complexing agent, chemical stability and the like. Incidentally, the complexing agents contain about 1 to thousands of ppm by weight of metal impurities such as Fe in commonly marketed reagents in some cases, so that the case where the complexing agents used in the invention become metal contamination sources is considered. These form stable complexes with the complexing agent in an early stage to exist. However, the complexing agent decomposes during use as a surface treating agent for a long period of time, and the metals liberate to easily adhere to the substrate surface. For this reason, in the complexing agent used in the invention, the content of each of the metal impurities such as Fe, Al and Zn previously contained is preferably 5 ppm by weight or less, and particularly preferably 2 ppm by weight or less. Such a purified complexing agent is obtained by performing purification, for example, by dissolving the complexing agent in an acidic or alkaline solution, then, removing insoluble impurities by separation by filtration, neutralizing the solution again to precipitate crystals, and separating the crystals from the solution.

<pH>

The pH of the cleaning solution of the invention is, as the lower limit, preferably 9.0 and more preferably 10.0, and, as the upper limit, preferably 13.0, more preferably 12.0 and particularly preferably 11.0. When the pH is the above-mentioned lower limit or more, it is preferred in terms of the contamination-removing effect. On the other hand, when the pH is the above-mentioned upper limit or less, it is preferred in terms of economic efficiency and difficulty of occurrence of surface roughening of the substrate.

<Preparation Method>

The preparation of the cleaning solution of the invention may be performed by a conventionally known method.

Of the respective constituent components of the cleaning solution, any two components or three or more components may be previously blended, followed by mixing the remaining components, or all may be mixed at once.

<Substrate for Cleaning (Semiconductor Device Substrate)>

The cleaning solution of the invention is used for cleaning of the substrate surfaces of semiconductor, glass, metal, ceramic, resin, magnetic body, superconductor and the like, in which metal contamination or particle contamination poses a problem. In particular, the cleaning solution is suitably used for cleaning of the surfaces of the semiconductor device substrates in production processes of the semiconductor device substrates for semiconductor elements, display devices or the like, in which the highly clean substrate surfaces are required. On the surfaces of these substrates, there may be present wirings, electrodes or the like. Materials of the wirings or the electrodes include semiconductor materials such as Si, Ge and GaAs; insulating materials such as SiO₂, silicon nitride, glass, low-dielectric constant (low-k) materials, aluminum oxide, transition metal oxides (titanium oxide, tantalum oxide, hafnium oxide, zirconium oxide and the like), (Ba, Sr)TiO₂ (BST), polyimides and organic thermosetting resins; metals such as W, Cu and Al or alloys thereof, silicides, nitrides and the like. The term “low-k materials” as used herein is a generic term of materials having a relative dielectric constant of 3.5 or less, compared with that silicon oxide such as TEOS has a relative dielectric constant of 3.8 to 3.9.

In particular, the cleaning solution of the invention is suitably used when reduction of fine particle contamination is very strongly desired in the semiconductor device substrate having the semiconductor material such as silicon or the insulating material such as silicon nitride, silicon oxide or glass, on a part or the whole of the surface thereof.

<Particle Contamination on Substrate>

In particular, the cleaning solution of the invention is excellent in removability of fine particles. The term “fine particles” means particles having a particle size of 0.06 to 10 μm. The fine particles on the semiconductor device substrate are measurable by using a laser surface inspection device (LS-6600 manufactured by Hitachi Engineering Co., Ltd.), as shown in Examples described later.

<Cleaning Method of Solution for Cleaning Semiconductor Device Substrate>

The method for cleaning the semiconductor device substrate by using the cleaning solution of the invention is usually performed by a method of bringing the cleaning solution into direct contact with the substrate. The methods of bringing the cleaning solution into contact with the substrate include a dip type in which a cleaning tank is filled with the cleaning solution and the substrate is dipped therein, a spin type in which the substrate is rotated at high speed while flowing the cleaning solution from a nozzle onto the substrate, a spray type in which the solution is sprayed to the substrate to perform cleaning, and the like. As an apparatus for performing such cleaning, there is a batch type cleaning apparatus of cleaning a plurality of substrates accommodated in a cassette at once, a sheet-fed type cleaning apparatus of cleaning one substrate fixed to a holder, or the like. The particles remaining on the substrate after cleaning potentially cause changes in dimension of wiring, changes in resistance, disconnection, changes in dielectric constant, and the like, in subsequent processes. It is therefore preferred that the particles are decreased.

The cleaning solution of the invention can remove fine contamination even when cleaning is performed under conditions of a low ultrasonic irradiation intensity. That is to say, it is possible to remove fine contamination without the occurrence of pattern inclination on the substrate, or the like. The ultrasonic irradiation is preferred in terms of being able to uniformly clean the substrate surface, and the like. The conditions of a low ultrasonic irradiation intensity are specifically an intensity of 1.5 W or less per cm² of so-called substrate to be irradiated with the ultrasonic wave which is a substrate for generating ultrasonic vibration for propagating a ultrasonic wave to the cleaning solution. The cleaning solution of the invention is extremely excellent in cleaning effect, so that the intensity of ultrasonic irradiation cleaning during cleaning is preferably 0.90 W or less, and more preferably 0.50 W or less, per cm² of substrate to be irradiated with ultrasonic wave. Further, the lower limit thereof is usually 0.2 W per cm² of substrate to be irradiated with ultrasonic wave. Incidentally, the intensity of conventional ultrasonic irradiation cleaning is from 3 to 10 W per cm² of substrate to be irradiated with the ultrasonic wave. When the ultrasonic irradiation is performed, the frequency of the ultrasonic wave irradiated to the substrate is preferably 0.5 MHz or more, and more preferably 0.9 MHz or more. Further, the upper limit of the frequency of the ultrasonic wave is usually 2.0 MHz.

The cleaning time is usually 30 seconds or more and preferably 1 minute or more, and usually 30 minutes or less and preferably 15 minutes or less, in the case of the batch type cleaning apparatus, and usually 1 second or more and preferably 5 seconds or more, and usually 15 minutes or less and preferably 5 minutes or less, in the case of the sheet-fed type cleaning apparatus. When the cleaning time is the above-mentioned lower limit or more, it is preferred in terms of cleaning effect. When the cleaning time is the above-mentioned upper limit or less, a decrease in throughput is difficult to occur. This is therefore preferred.

Conventionally, the cleaning solution is heated to about 60° C. to use for the purpose of improving cleaning effect. However, the cleaning solution of the invention has high cleaning effect, so that cleaning effect can be sufficiently exhibited even at low temperatures, specifically, even at 10 to 50° C., further even at 20 to 40° C. As described above, 10° C. or more, further 20° C. or more is desirable, and 50° C. or less, further 40° C. or less is desirable.

In the case of 35° C. or less, the etching rate can be suppressed extremely low, compared to the case of 40° C., when a film formed on the substrate surface is either a thermally-oxidized film or a polysilicon film.

### EXAMPLES

The invention will be described below in further detail with reference to Examples and Comparative Examples. However, the invention is not construed as being limited to the following Examples within the range not departing from the gist of the invention.

<Measurement of Number of Fine Particles on Substrate Surface>

The fine particles (0.06 to 10 μm) on the substrate surface were measured by using the laser surface inspection device (“LS-6600” manufactured by Hitachi Electronics Engineering Co., Ltd.), using 0bM06h.idp as a process condition file, 0bM06h.sys as a sensitivity condition file and ACTUAL (actual number count) as a numerical value. Further, the particle removal rate was determined from the numbers of Si₃N₄ particles on the silicon wafer surface before and after cleaning, according to the following equation. Incidentally, each measurement was made for two wafers, and the average value thereof was determined.

Removal rate(%)={[(c−a)−(b−a)]/(b−a)}×100

wherein a represents the number of particles before contamination, b represents the number of particles after contamination, and c represents the number of particles after cleaning.

<Preparation of Silicon Wafer Surface-Contaminated with Si₃N₄ Particles>

An 8-inch silicon wafer (an 8-inch silicon wafer with 340 to 531 particles/8 inches having a particle size of 0.06 to 10 μm adhered before contamination) manufactured by SUMCO Corporation was dipped in an aqueous hydrochloric acid solution (hydrochloric acid concentration: 11 ppm by weight) containing about 0.4 μg/liter of Si₃N₄ particles (“Alfa Aesar®” imported from Johnson Matthey Japan Incorporated), and held for 15 minutes while oscillating at a frequency of one every 2.5 minutes. After dipping, the wafer was washed with ultrapure water for 5 minutes, and dried by using a spin dryer (“H840” manufactured by Kokusan Co., Ltd.) to obtain a silicon wafer with 10,223 to 12,835 Si₃N₄ particles/8 inches having a particle size of 0.06 to 10 μM adhered.

### Example 1

Twenty-one silicon wafers manufactured by SUMCO Corporation, which were surface-contaminated with Si₃N₄ particles, were dipped in 10 liters of a solution obtained by adding component (D) shown in Table 1, C₄H₉O(CH₂CH₂O)₂H, to an APM cleaning solution (a mixed aqueous solution of 29% by weight aqueous ammonia, 31% by weight aqueous hydrogen peroxide and water at a volume ratio of 1:2:80, a mixed solution of components (A) to (C) of Table 1). The pH of the dipping solution was 10.5, the solution temperature during dipping was 30° C., and the cleaning time was 5 minutes. During dipping, using a high-frequency ultrasonic cleaning apparatus (oscillator: “Type 68101” manufactured by Kaijo Corporation, vibrating plate: “Type 7857S” manufactured by Kaijo Corporation), this vibrating plate as a substrate irradiated with ultrasonic wave was allowed to generate an ultrasonic wave having a frequency of 950 kHz and an intensity of 0.45 W/cm² to perform ultrasonic irradiation to the cleaning solution. The silicon wafers after dipping were washed with ultrapure water for 10 minutes, and dried by using a spin dryer (“H840” manufactured by Kokusan Co., Ltd.). Incidentally, in Examples of the invention, a temperature-controlled bath was used as a liquid bath in order to control the solution temperature, and when there is an increase in temperature due to reaction heat, a cooling function is actuated so as to be capable of being maintained at a preset temperature.

The numbers of particles on surfaces of the 11th and 13th of the 21 silicon wafers were measured by using a laser surface inspection device. To the substrates after dipping, 828 particles/8 inches of Si₃N₄ particles having a particle size of 0.06 to 10 μm were adhered. Further, the particle removal rate was determined from the numbers of Si₃N₄ particles on the silicon wafer surface before and after cleaning. As a result, it was 97%.

### Example 2

Cleaning was performed in the same manner as in Example 1 except that the content of component (D) was changed to 500 ppm. The number of Si₃N₄ particles having a particle size of 0.06 to 10 um decreased from 12,835 particles/8 inches to 870 particles/8 inches by the cleaning, and the particle removal rate was 98%.

### Example 3

Cleaning was performed in the same manner as in Example 1 except that the temperature of the cleaning solution was changed to 40° C. The number of Si₃N₄ particles having a particle size of 0.06 to 10 μm decreased from 11,988 particles/8 inches to 900 particles/8 inches by the cleaning, and the particle removal rate was 97%.

### Example 4

Cleaning was performed in the same manner as in Example 1 except that the temperature of the cleaning solution was changed to 50° C. The number of Si₃N₄ particles having a particle size of 0.06 to 10 μm decreased from 11,384 particles/8 inches to 596 particles/8 inches by the cleaning, and the particle removal rate was 98%.

### Comparative Example 1

Cleaning was performed in the same manner as in Example 1 except that no component (D) was added to the cleaning solution. The number of Si₃N₄ particles having a particle size of 0.06 to 10 gm only decreased from 10,423 particles/8 inches to 2,119 particles/8 inches by the cleaning, and the particle removal rate was 83%.

### Comparative Example 2

Cleaning was performed in the same manner as in Example 1 except that HO(CH₂CH₂O)₂H was used as component (D). The number of Si₃N₄ particles having a particle size of 0.06 to 10 gm only decreased from 10,223 particles/8 inches to 2,108 particles/8 inches by the cleaning, and the particle removal rate was 84%.

### Comparative Example 3

Cleaning was performed in the same manner as in Example 1 except that n-methyl-2-pyrrolidone was used as component (D). The number of Si₃N₄ particles having a particle size of 0.06 to 10 μm only decreased from 10,427 particles/8 inches to 2,000 particles/8 inches by the cleaning, and the particle removal rate was 84%.

### Comparative Example 4

The cleaning was prepared in the same manner as in Example 1 except that diethylene glycol monohexyl ether (C₆H₁₃O(CH₂CH₂O)₂H) was used as component (D). However, diethylene glycol monohexyl ether did not dissolved in the APM solution.

These results show that the cleaning solutions of the invention have excellent particle removability even when the intensity of ultrasonic irradiation at the time of cleaning is low.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Component (A) | Hydrogen peroxide: 0.8 wt % | | | | | | |
| Component (B) | Ammonium hydroxide: 0.3 wt % | | | | | | |
| Component (C) | Ultrapure water | | | | | | |
| Component (D) | C₄H₉O(CH₂CH₂O)₂H | | | | Not added | HO(CH₂CH₂O)₂H | n-Methyl-2- |
| | | | | | | | pyrrolidone |
| | 1,000 wt ppm | 500 wt ppm | 1,000 wt ppm | | — | 1,000 wt ppm | |
| pH | 10.5 | | | | | | |
| Temperature | 30° C. | | 40° C. | 50° C. | 30° C. | | |
| Ultrasonic Intensity | 0.45 W · cm⁻² | | | | | | |
| Number of Particles | 513 | 500 | 512 | 404 | 423 | 527 | 340 |
| before Contamination | | | | | | | |
| Number of Particles | 12,096 | 12,835 | 11,988 | 11,384 | 10,423 | 10,223 | 10,427 |
| before Cleaning | | | | | | | |
| Number of Particles | 828 | 870 | 900 | 595 | 2,119 | 2,108 | 2,000 |
| after Cleaning | | | | | | | |
| Particle Removal Rate | 97 | 98 | 97 | 98 | 83 | 84 | 84 |
| [%] | | | | | | | |

Examples 5 to 8 and Comparative Examples 4 to 7 will be described below.

### Example 5

As 8-inch silicon wafers used herein, there were used new wafers manufactured by MCME Corporation, which were treated with an APM cleaning solution. The number of fine particles before contamination was about 200 particles/8-inch silicon wafer.

In the same manner as in Example 1 described above, the wafers were surface-contaminated with Si₃N₄ particles to about 10,000 particles/8-inch silicon wafer.

First, cleaning was performed in the same manner as in Example 1 under respective conditions as shown in Table 2.

Twenty-one silicon wafers surface-contaminated with Si₃N₄ particles were dipped in 10 liters of a solution obtained by adding component (D) shown in Table 2, diethylene glycol mono-n-butyl ether: C₄H₉O(CH₂CH₂O)₂H, to an APM cleaning solution (a mixed aqueous solution of 29% by weight aqueous ammonia, 31% by weight aqueous hydrogen peroxide and water at a volume ratio of 1:2:80, a mixed solution of components (A) to (C) of Table 2). The pH of the dipping solution was 10.5, the solution temperature during dipping was 25° C., and the cleaning time was 5 minutes. In this example, during dipping, using a high-frequency ultrasonic cleaning apparatus (oscillator: “Type 68101” manufactured by Kaijo Corporation, vibrating plate: “Type 7857S” manufactured by Kaijo Corporation), this vibrating plate as a substrate irradiated with ultrasonic wave was allowed to generate an ultrasonic wave having a frequency of 950 kHz and an intensity of 0.45 W·cm⁻² to perform ultrasonic irradiation to the cleaning solution. The silicon wafers after dipping were washed with ultrapure water for 10 minutes, and dried by using a spin dryer (“H840” manufactured by Kokusan Co., Ltd.).

The results thereof are shown in Table 2. It is revealed that when component (D) is added, even if the solution temperature is a low temperature (25° C.), the wafers have excellent particle removal performance.

Further, using an 8-inch silicon wafer having a thermally-oxidized film (purchased from Advantec Co., Ltd.) and an 8-inch silicon wafer having a polysilicon film (purchased from Advantec Co., Ltd.), the etching rate of both film of the thermally-oxidized film and the polysilicon film was measured.

The above-mentioned respective evaluation substrates were dipped in an SPM cleaning solution (a mixed aqueous solution of 97% by weight sulfuric acid/31% by weight aqueous hydrogen peroxide at a volume ratio of 4/1) as a pretreatment for 10 minutes, and then, washed with ultrapure water for 10 minutes. Thereafter, the substrates were dipped in a 0.5% by weight HF aqueous solution for 5 minutes, then, washed with ultrapure water for 10 minutes, and dried by using a spin dryer (“H840” manufactured by Kokusan Co., Ltd.). The each initial film thickness was measured by using a nanospec (“NANOSPEC M210XP-FSCL” manufactured by Nanometrics Japan Ltd.).

The 8-inch silicon wafer having the thermally-oxidized film was dipped in each cleaning solution for 15 minutes, and the 8-inch silicon wafer having the polysilicon film was dipped for 5 minutes. Thereafter, the respective silicon wafers were washed with ultrapure water for 10 minutes, and dried by using the spin dryer (“H840” manufactured by Kokusan Co., Ltd.). Then, the film thickness was measured by using the nanospec (“NANOSPEC M210XP-FSCL” manufactured by Nanometrics Japan Ltd.). The etching rate was calculated by dividing the amount of film decrease from the initial film thickness by the dipping time of each film.

The etching rate of the thermally-oxidized film was 0.2 angstrom/min or less, and the etching rate of the polysilicon film was 1 angstrom/min or less.

### Example 6

Cleaning was performed in the same manner as in the above-mentioned embodiment 5 except that the temperature was changed to 30° C. The same results as in Example 5 were obtained except that the particle removal rate increased to 90%.

### Example 7

Cleaning was performed in the same manner as in the above-mentioned embodiment 5 except that the temperature was changed to 35° C. The same results as in Example 5 were obtained except that the particle removal rate increased to 91%.

### Example 8

Cleaning was performed in the same manner as in the above-mentioned embodiment 5 except that the temperature was changed to 40° C. The particle removal rate increased to 90%, and the etching rate of polysilicon increased to 1.3 angstroms/min.

### Comparative Example 4

Cleaning was performed in the same manner as in Example 5 except that no component (D) was added to the cleaning solution. The same results as in Example 5 were obtained except that the particle removal rate was 65%.

### Comparative Example 5

Cleaning was performed in the same manner as in Example 6 except that no component (D) was added to the cleaning solution. The same results as in Example 6 were obtained except that the particle removal rate was 64%.

### Comparative Example 6

Cleaning was performed in the same manner as in Example 7 except that no component (D) was added to the cleaning solution. The same results as in Example 7 were obtained except that the particle removal rate was 71%.

### Comparative Example 7

Cleaning was performed in the same manner as in Example 8 except that no component (D) was added to the cleaning solution. The same results as in Example 5 were obtained except that the particle removal rate was 69%.

From the above results of Examples 5 to 8 and Comparative Examples 4 to 7, the etching rate of the thermally-oxidized film was 0.2 angstrom/min or less at 40° C. or less for both of Example in which component (D) was added to the cleaning solution and Comparative Example in which no component (D) was added. On the other hand, the etching rate of the polysilicon film was 1 angstrom/min or less at up to 35° C. for the both. However, the etching rate increased to 1.3 angstroms/min at 40° C. for the both.

These results show that the cleaning temperature is desirably 35° C. or less in order to avoid etching to the substrates.

The above results show that the cleaning method of the invention can remove particles at low temperatures without causing damage to the silicon substrates.

TABLE 2

| | | | | | Comparative | Comparative | Comparative | Comparative |
|---|---|---|---|---|---|---|---|---|
| | Example 5 | Example 6 | Example 7 | Example 8 | Example 4 | Example 5 | Example 6 | Example 7 |
| Component (A) | Hydrogen peroxide: 0.8 wt % | | | | | | | |
| Component (B) | Ammonium hydroxide: 0.3 wt % | | | | | | | |
| Component (C) | Ultrapure water | | | | | | | |
| Component (D) | Diethylene glycol mono-n-butyl ether | | | | Not added | | | |
| | 1,000 wt ppm | | | | — | | | |
| pH | 10.5 | | | | | | | |
| Temperature [° C.] | 25 | 30 | 35 | 40 | 25 | 30 | 35 | 40 |
| Ultrasonic Intensity | 0.45 | | | | | | | |
| [W · cm⁻²] | | | | | | | | |
| Particle Removal Rate | 85 | 90 | 91 | 90 | 65 | 64 | 71 | 69 |
| [%] | | | | | | | | |
| Etching Rate of | <0.2 | <0.2 | <0.2 | <0.2 | <0.2 | <0.2 | <0.2 | <0.2 |
| Thermally-Oxidized | | | | | | | | |
| Film | | | | | | | | |
| [angstrom/min] | | | | | | | | |
| Etching Rate of | <1 | <1 | <1 | 1.3 | <1 | <1 | <1 | 1.3 |
| Polysilicon Film | | | | | | | | |
| [angstrom/min] | | | | | | | | |

Examples 9 to 12 and Comparative Examples 8 to 11 will be described below.

Using silicon wafers manufactured by MEMC Corporation as 8-inch silicon wafers for evaluation, cleaning was performed in the same manner as in Example 1 under the respective conditions of Table 3. The ultrasonic intensity was changed to 0.2 W·cm⁻², 0.45 W·cm⁻², 0.8 W·cm⁻² and 1.4 W·cm⁻² herein, and the other conditions were the same as in Example 1 and Comparative Example 1.

The results thereof are shown in Table 3.

It is revealed that when the glycol ether-based compound represented by compound (D) was added to the cleaning solution, the wafers have excellent particle removal performance at a low temperature (30° C.) even in the case where the ultrasonic intensity is low.

TABLE 3

| | | | | | Comparative | Comparative | Comparative | Comparative |
|---|---|---|---|---|---|---|---|---|
| | Example 9 | Example 10 | Example 11 | Example 12 | Example 8 | Example 9 | Example 10 | Example 11 |
| Component (A) | Hydrogen peroxide: 0.8 wt % | | | | | | | |
| Component (B) | Ammonium hydroxide: 0.3 wt % | | | | | | | |
| Component (C) | Ultrapure water | | | | | | | |
| Component (D) | Diethylene glycol mono-n-butyl ether | | | | Not added | | | |
| | 1,000 wt ppm | | | | — | | | |
| pH | 10.5 | | | | | | | |
| Temperature [° C.] | 30 | | | | | | | |
| Ultrasonic Intensity | 0.2 | 0.45 | 0.8 | 1.4 | 0.2 | 0.45 | 0.8 | 1.4 |
| [W · cm⁻²] | | | | | | | | |
| Particle Removal | 46 | 79 | 73 | 83 | 17 | 56 | 48 | 59 |
| Rate [%] | | | | | | | | |

Examples 13 and 14 will be described below.

Using silicon wafers manufactured by MEMC Corporation as 8-inch silicon wafers for evaluation, cleaning was performed in the same manner as in Example 1 (ultrasonic intensity: 0.45 W·cm⁻²) except that triethylene glycol mono-n-butyl ether was used in place of diethylene glycol mono-n-butyl ether in Example 1, as the glycol ether-based compound represented by component (D), in Example 14. Further, in Example 13, only the ultrasonic intensity was changed to 0.2 W·cm⁻².

The results thereof are shown in Table 4. For the particle removal rate, it is revealed that the wafers are excellent in particle removability similarly to the case of diethylene glycol mono-n-butyl ether, compared to the APM cleaning solution (Comparative Examples 8 and 9).

TABLE 4

| | Example 13 | Example 14 |
|---|---|---|
| Component (A) | Hydrogen peroxide: 0.8 wt % | |
| Component (B) | Ammonium hydroxide: 0.3 wt % | |
| Component (C) | Ultrapure water | |
| Component (D) | Triethylene glycol mono-n-butyl ether | |
| | 1,000 wt ppm | |
| pH | 10.5 | |
| Temperature [° C.] | 30 | |
| Ultrasonic Intensity [W · cm⁻²] | 0.2 | 0.45 |
| Particle Removal Rate [%] | 31 | 76 |

Comparative Examples 12 and 13 will be described below.

In Comparative Example 12, cleaning was performed using wafers manufactured by MEMC Corporation as 8-inch silicon wafers for evaluation in the same manner as in Example 5 except that 40 ppm by weight of a surfactant (ROEO type) represented by a structural formula of C₁₂H₂₅O(C₂H₄O)₁₁H was added in place of the ethylene glycol-based compound of component (D) and that the cleaning temperature was 45° C.

Further, in Comparative Example 13, cleaning was performed using wafers manufactured by MEMC Corporation as 8-inch silicon wafers for evaluation in the same manner as in Comparative Example 12 except that no component (D) was added.

The results thereof are shown in Table 5. The particle removal rate is the same level (70%) as that of the APM cleaning solution, and it is revealed that the cleaning method and cleaning solution of the invention to which the glycol ether-based compound is added are excellent in particle removal rate at a low temperature and low ultrasonic intensity.

TABLE 5

| | Comparative | Comparative |
|---|---|---|
| | Example 12 | Example 13 |
| Component (A) | Hydrogen peroxide: 0.8 wt % | |
| Component (B) | Ammonium hydroxide: 0.3 wt % | |
| Component (C) | Ultrapure water | |
| Component (D) | C₁₂H₂₅O(C₂H₄O)₁₁H | Not added |
| | 40 wt ppm | — |
| pH | 10.5 | |
| Temperature [° C.] | 45 | |
| Ultrasonic Intensity [W · cm⁻²] | 0.45 | |
| Particle Removal Rate [%] | 70 | 70 |

While the invention has been described in detail with reference to the specific embodiments, it will be apparent to those skilled in the art that various changes and modifications can be made without departing from the spirit and scope of the invention.

This application is based on Japanese Patent Application (No. 2007-313487) filed on Dec. 4, 2007, the contents of which are hereby incorporated by reference.

1. A method for cleaning a semiconductor device substrate, the method comprising cleaning the semiconductor device substrate while applying an ultrasonic wave having an intensity of 0.2 W or more and 1.5 W or less per cm² of substrate to be irradiated with the ultrasonic wave by using a cleaning solution comprising the following components (A) to (D):
(A) hydrogen peroxide,
(B) an alkali,
(C) water, and
(D) a compound represented by the following general formula (1):
R¹—O—(—R²—O—)ₙ—H(1) (I)
wherein R¹ represents an alkyl group having 1 to 4 carbon atoms, R² represents an alkylene group having 2 to 3 carbon atoms, and n represents an integer of 1 to 3.

2. A method for cleaning a semiconductor device substrate, the method comprising using a cleaning solution comprising the following components (A) to (D):
(A) hydrogen peroxide,
(B) an alkali,
(C) water, and
(D) a compound represented by the following general formula (1):
R¹—O—(—R²—O—)ₙ—H(1) (I)
wherein R¹ represents an alkyl group having 1 to 4 carbon atoms, R² represents an alkylene group having 2 to 3 carbon atoms, and n represents an integer of 1 to 3,
wherein the semiconductor device substrate is cleaned while applying an ultrasonic wave having a frequency of 0.5 MHz or more.

3. The method for cleaning a semiconductor device substrate according to claim 1 or 2, wherein a solution temperature of said cleaning solution at the time of cleaning is from 20 to 50° C.

4. The method for cleaning a semiconductor device substrate according to claim 1 or 2, wherein the pH of said cleaning solution is from 9.0 to 12.0.

5. The method for cleaning a semiconductor device substrate according to claim 1 or 2, wherein a content of said component (D) is from 50 to 5,000 ppm by weight.

6. The method for cleaning a semiconductor device substrate according to claim 1 or 2, wherein said component (B) is ammonium hydroxide.

7. The method for cleaning a semiconductor device substrate according to claim 1 or 2, wherein a content of said component (B) is from 0.01 to 10% by weight.

8. A composition comprising the following components (A) to (D):
(A) hydrogen peroxide,
(B) an alkali,
(C) water, and
(D) a compound represented by the following general formula (1):
R¹—O—(—R²—O—)ₙ—H(1) (I)
wherein R¹ represents an alkyl group having 1 to 4 carbon atoms, R² represents an alkylene group having 2 to 3 carbon atoms, and n represents an integer of 1 to 3, wherein a content of the above-mentioned component (A) is from 0.01 to 10% by weight,
a content of the above-mentioned component (B) is from 0.005 to 5% by weight,
a content of the above-mentioned component (C) is from 85 to 99.5% by weight, and
a content of the above-mentioned component (D) is from 50 to 5,000 ppm by weight.
